(19) United States
(12) Patent Application Publication
(10) Pub. No.: US 2005/0005565 A1
(43) Pub. Date: Jan. 13, 2005

(54) Bumper construction

(76) Inventors: Brian McSharry, Palatine, IL (US); Phil Klopp, Palatine, IL (US); Frank Quartarone, Palatine, MA (US)

Correspondence Address: Law Offices;Jacobson Holman, Professional Limited Liability Company, 400 Seventh Street, N.W., Washington, DC, 20004-2218, US

(21) Appl. No.: 10/843,559

(22) Filed: May 12, 2004

Related U.S. Application Data
(60) Provisional application No. 60/473,467, filed on May 28, 2003.

(51) Int. Cl. B60R 19/04; E04C 2/38

(52) U.S. Cl. 52/716.5; 52/716.1

(57) ABSTRACT

A protective bumper strip assembly for protecting surfaces such as walls, display cases, furniture, and the like, from damage caused by inadvertent impact. The protective bumper strip assembly comprises a base member attachable to a supporting surface to be protected and a bumper that is press-fit or snap-fit to the base member. The press-fit interconnection is formed from male and female interconnecting elements to form a mechanical connection therebetween. The male and female interconnecting elements include a high friction material to prevent slippage therebetween when the bumper is impacted. The interengagement between the base member and the bumper requires no additional interconnecting or attachment members. The base member includes a pair of elongated arcuate male members which receive arcuate complementary female interconnecting elements extending from the bumper. Free end portions of the assembly may include cap elements of flat or spherical shape to enclose the ends of the strip assemblies.

This is a complete application claiming benefit of provisional application Ser. No. 60/473,467 filed May 28, 2003.

### BACKGROUND OF THE INVENTION

1. Field of the Invention

This invention relates generally to protective bumper systems, and relates more particularly to strip assemblies for protecting surfaces such as walls, display cases, furniture, and the like, from damage caused by inadvertent impact.

2. Discussion of the Prior Art

Wall surfaces in hallways, particularly in heavily trafficked areas such as hospital corridors, airport walkways and the like, are commonly exposed to impact damage resulting from misguided carts, gurneys, people movers and the like. Likewise, grocery island cases, freezer chests, merchandise display cases, and other such items found in supermarkets, pharmacies, and department and specialty stores are often damaged in a similar manner.

To minimize such damage, bumper guards or strip assemblies of various designs have been proposed for surface mounting as chair rails, or to otherwise absorb impacts on flat walls or about corners of such structures. Protective devices of this nature must not only be functionally effective to absorb repeated impacts from different directions, but they must be simple and inexpensive to manufacture and utilize, and aesthetically pleasing, as well.

Bumper guards and the like commercially available heretofore tend to compromise one or more of the foregoing criteria. For example, in order to improve impact resistance, some products are unduly complex, making them relatively expensive to manufacture. To minimize manufacturing costs, other products may not provide adequate protection to the surfaces on which they are mounted, or may tend to deteriorate quickly in use. Finally, some such strip assemblies fail to hide the mounting hardware or otherwise present an unsightly appearance which is commercially undesirable.

### SUMMARY OF THE INVENTION

It is a primary object of this invention to provide several embodiments of bumper assemblies, each of which include a base member to be attached to a surface to be protected with a top or bumper which is easily and securely affixed to the base without the need for tools to reduce installation time while providing a functionally effective, active locking, assembly where the bumper element will not be easily disengaged from the base regardless of the angle of impact against the arched surface of the bumper.

Another object of this invention is to provide an impact deflection system which includes mechanical and frictional anti-slip and anti-shrink properties to preclude or significantly reduce inadvertent lateral movement between the bumper and the base in use even after repeated impacts.

A further object of this invention is the provision of a protective strip assembly with a vinyl top or bumper element which, in some embodiments, is “rigid”, providing high impact strength in an inexpensive manner and, in other embodiments, is “flexible”, providing superior radius capability while maintaining its geometry to insure maximum protection where it is needed most. Extended lengths of such bumpers can be flexed to permit access to the underside so that the screws or the like securing the base to the surface to be protected can be hidden in the final assembly.

Still another object of this invention is to provide a bumper construction which, in addition, to the interengageable locking base and bumper elements, is designed to interact with a full range of injection molded flexible vinyl caps and corners to enable the bumper assembly to be used in a straight run or continuously around corners of a square or rectangular unit, or even a hexagonal, or other shaped unit.

Yet another object of this invention is the provision of a bumper construction of the type described wherein the bumper elements can be extruded from relatively rigid plastics materials or co-extruded from relatively rigid and relatively flexible plastics materials and the bases can be pre-slotted and extruded aluminum or plastics materials for straight runs or radius application, producing an assembly of parts which is simple and inexpensive to manufacture, install and use, offers high shatter resistance with a professional finish in a variety of colors to produce a highly attractive appearance in the final product.

It is to be understood that the instant inventive concepts are not limited by size or materials although, to facilitate a better understanding of the invention, illustrative embodiments of 1″ and 2″ bumper construction elements are illustrated and preferred materials for each of the elements are disclosed.

Upon further study of the specification, additional objects and advantages of this invention will become apparent to those skilled in the art.

### BRIEF DESCRIPTION OF THE DRAWINGS

These and other objects, features and many of the attendant advantages of this invention will be better understood by those with ordinary skill in the art in connection with the following detailed description of the preferred embodiments and the accompanying drawings wherein:

FIG. 1 is a fragmentary perspective view of a 1″ base element according to the instant inventive concepts;

FIG. 1A is an end elevational view of the base element of FIG. 1 with a frictional coating such as thermoplastic polyurethane (TPU) schematically shown on the bulbous projections to minimize movement of the bumper relative to the base even after repeated impact from different directions;

FIG. 2 is a fragmentary perspective view of a 1″ top or bumper element formed of relatively “rigid” plastics material such as polyvinyl chloride (PVC);

FIG. 3 is an end view of the assembly of the bumper element of FIG. 2 with the base element of FIG. 1;

FIG. 4 is an end elevational view of a 1″ bumper element including a relatively “flexible” PVC or the like arch co-extruded with a relatively “rigid” PVC or the like bridge according to the instant inventive concepts;

FIG. 5 is an end elevational view of the assembly of the bumper element of FIG. 4 with the base element of FIG. 1;

FIG. 6 is an end elevational view of a 2″ base element according to the instant inventive concepts;

FIG. 6A is a view similar to FIG. 1A showing the bulbous projections of the base element of FIG. 6 coated with a frictional material;

FIG. 7 is an end elevational view of a 2″ “rigid” bumper element;

FIG. 8 is an end elevational view of the assembly of the bumper element of FIG. 7 with the base element of FIG. 6;

FIG. 9 is a cross-sectional view through a 2″ co-extruded “flexible” bumper element according to this invention;

FIG. 10 is a cross-sectional view through the assembly of the bumper element of FIG. 9 with the base element of FIG. 6;

FIG. 11 is a cross-sectional view through the bumper assembly of FIG. 10 attached to a wall or fixture, the surface of which is to be protected;

FIG. 12 is an end elevational view of a 1″ “quick stop” cap for use with a bumper assembly according to this invention;

FIG. 13 is a cross-sectional view thereof taken along lines A-A of FIG. 12;

FIG. 14 is a top plan view of the stop cap of FIG. 12;

FIG. 15 is an end elevational view showing the stop cap of FIGS. 12-14 engaged with a bumper assembly as shown in FIG. 3;

FIGS. 16-19 are views of a 2″ “quick stop” cap similar to the views of the 1″ quick stop cap illustrated in FIGS. 12-15;

FIG. 20 is an end elevational view of a 1″ “snap-on” cap for % use with a bumper assembly according to this invention;

FIG. 21 is a cross-sectional view thereof taken along lines A-A of FIG. 20;

FIG. 22 is an enlarged detail of the female connector of the bumper element shown within the dotted circle in FIG. 20;

FIG. 23 is a top plan view of the 1″ snap-on cap of FIG. 20;

FIG. 24 is an end elevational view showing the snap-on cap of FIGS. 20-23 engaged with a bumper assembly such as shown in FIG. 3;

FIGS. 25-29 are views of a 2″ snap-on cap similar to the views of the 1″ snap-on cap illustrated in FIGS. 20-24;

FIG. 30 is an end elevational view of a 1″ “snap-on 90°” cap for use with a bumper assembly according to this invention;

FIG. 31 is a cross-sectional view thereof taken along lines A-A of FIG. 30;

FIG. 32 is an enlarged detail view of the female connector of the bumper element shown within the dotted circle in FIG. 30;

FIG. 33 is an end elevational view of one end of the snap-on 90° cap of FIG. 30 engaged with a bumper assembly such as shown in FIG. 3;

FIGS. 34-37 are views of a 2″ snap-on 90° cap similar to the views of the 1″, snap-on 90° cap shown in FIGS. 30-33;

FIG. 38 is an end elevational view of an illustrative 1″ “snap-on” cap of a different angle according to this invention;

FIG. 39 is a cross-sectional view thereof taken along lines A-A of FIG. 38;

FIG. 40 is an enlarged detail of the female connector of the bumper element shown within the dotted circle in FIG. 38;

FIG. 41 is an end elevational view of one end of the snap-on cap of FIG. 38 engaged with a bumper assembly such as shown in FIG. 3; and

FIGS. 42-45 are views of a 2″, snap-on cap similar to the views of the 1″ snap-on cap illustrated in FIGS. 38-41.

Like reference characters refer to like parts throughout the several views of the drawings.

### DETAILED DESCRIPTION OF THE PREFERRED EMBODIMENTS

The foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation of the preferred embodiments shown and described. Rather, all suitable modifications and equivalents may be resorted to, falling within the scope of the invention.

Referring now to the drawings, and more particularly to FIG. 1, a preferred form of base element according to the instant inventive concepts is designated generally by the reference numeral 50 and, although only a short portion is illustratively seen in FIG. 1, the element 50 can be of indeterminate length depending upon its application. The base element 50 is preferably extruded, either from a “rigid” plastics material such as PVC or from aluminum, although other materials may be substituted therefor without departing from the instant inventive concepts. The term “rigid” PVC is well understood by those with ordinary skill in this art.

The base element 50 comprises a floor portion 52, and a pair of longitudinally extending, transversely spaced, male connectors 54, each comprising a stem portion 56 and a bulbous head 58. Although not shown, the floor 52 can be pre-slotted or scored for passage or location of screws or the like adapted to attach the base element 50 to a wall or a fixture to be protected.

With reference now to FIG. 1A, the upper surfaces of the bulbous heads 58 of the male elements 54 may be coated with a friction-producing material 59 such as thermoplastic polyurethane (TPU) for a purpose to be described further hereinafter. If the base element 50 is formed of a plastics material such as PVC, the TPU may be co-extruded with the PVC in a well known manner.

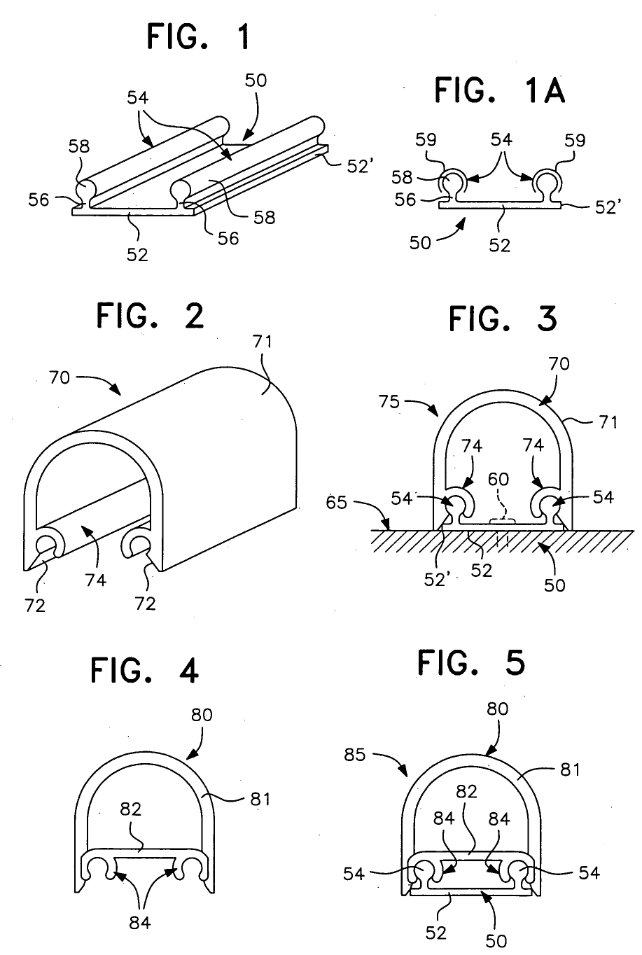

With reference now to FIGS. 2 and 3, one form of a top or bumper element according to this invention is shown at 70 as comprising an extruded arch 71 preferably formed of a “rigid” PVC. The lower inner longitudinal edges of the bumper element 70 are angled as seen at 72 and a pair of inwardly extending arcuate female connectors 74, whose internal surfaces are complementary to the bulbous heads 58 of the male elements 54 on the base element 50, are integrally extruded with the arch 71.

In use, the base element 50 is screwed or otherwise attached as by screws 60 to a supporting surface schematically seen at 65, and the female connectors 74 of the top or bumper element 70 are simply pressed into place on the bulbous heads 58 of the male connectors 54 to form the assembly 75 seen in FIG. 3. Thus, once the base element and the caps or corners to be discussed below are secured to the supporting surface, no tools are necessary to complete the assembly. Moreover, the unique complementary nature of the arcuate female connectors 74 provides both inner and outer engagement with the bulbous heads 58 of the male connectors 54 to resist disengagement or damage to the bumper assembly 75 from repeated impacts, regardless of the angle of impact. Moreover, the frictional TPU coating 59 enhances the engagement of the base element 50 and the bumper element 70 to preclude “shrinkage”, that is, compression of the bumper element 70 which can result from repeated impacts causing the bumper element 70 to slide along the base element 50 causing separation at the ends of the bumper assembly 75. If desired, the upper surfaces of the male connectors 54 or the inner surfaces of the female connectors 74 or both can be grooved or ribbed to enhance the mechanical engagement between these elements.

The manner in which the angled surfaces 72 of the bumper element 70 extend down along the outside edges 52′ of the base element 52, and the hidden screws 60 attaching the base element 50 to the supporting surface 65, allows the aesthetic value to be maintained well after installation.

Referring now to FIGS. 4 and 5, a “flexible” 1″ bumper element 80 is shown as a co-extrusion of a more resilient plastics material such as PVC forming the arch 81 with an internal, co-extruded, more rigid, PVC bridge 82 defining the female connectors 84 for attachment to the base element 50 to form the assembly 85 as seen in FIG. 5. In this manner, while the connection between the base element 50 and the bumper element 80 is between relatively rigid plastics materials, the more resilient material of the arch 81 provides a superior radius capability which maintains its geometry to ensure maximum protection where it is needed most. Once again, however, particularly with a coating 59 of TPU or the like on the bulbous heads 58 of the base element 50, the assembly 85 seen in FIG. 5 resists “shrinkage” and slippage between the elements even with repeated impacts from different directions.

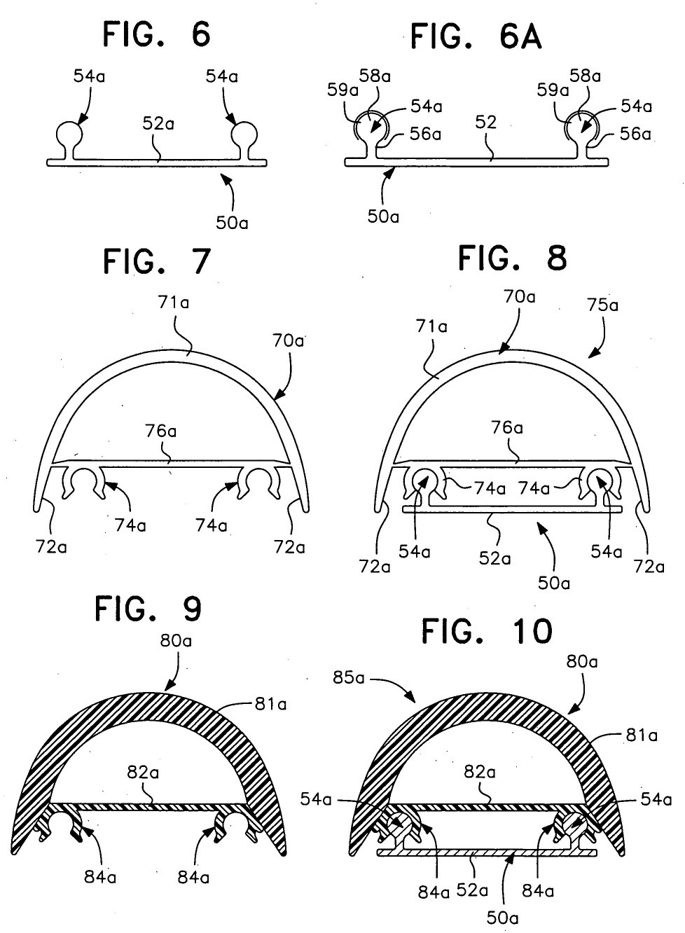

With reference to FIGS. 6, 6A and 7-10, parts of a 2″ bumper assembly similar to the bumper assembly of FIGS. 1, 1A and 2-5, are identified by the same reference characters followed by the suffix “a”. For all intents and purposes, other than the size and curvature of the parts, the elements are substantially identical with the exception that, in the rigid bumper element 70a of FIGS. 7 and 8, a bridge 76a interconnects the female connectors 74a to the arch 71a.

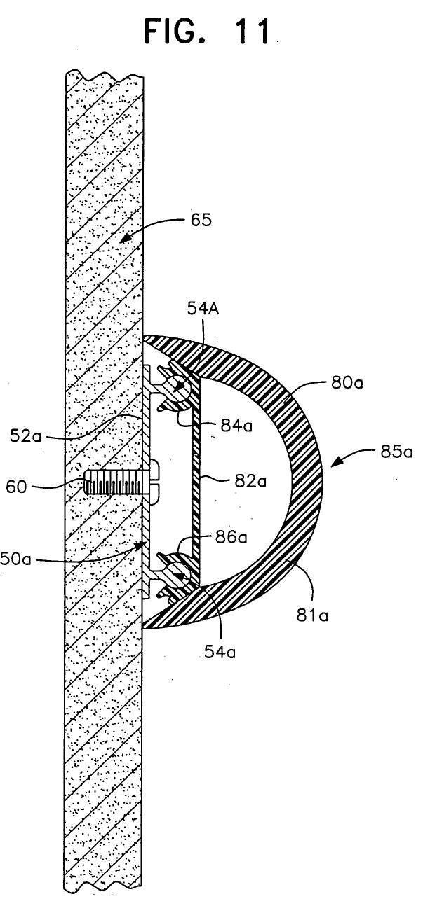

For illustrative purposes, the flexible 2″ bumper element 80a in FIGS. 8 and 9 has been cross-hatched for two different types of plastics material and the base element 50a has been cross-hatched for metal, e.g., aluminum. However, it is to be understood that the materials of the various elements can be varied within the skill of the art. Additionally, the drawings are not to be considered to scale and, as noted above, the 1″ and 2″ bumper assemblies have been shown merely as illustrative of the variations in size and construction of the elements of the impact deflection system of this invention. FIG. 11 illustrates the manner in which a bumper assembly, in this instance, the 2″ flexible bumper assembly 85a of FIG. 10, is attached to a vertical supporting surface 65.

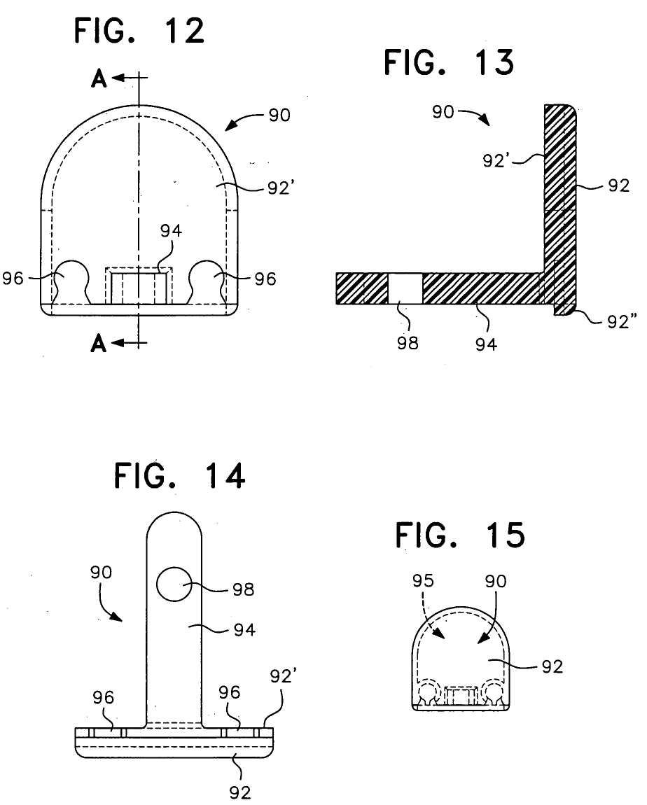

Referring now to FIGS. 12-15, a 1″ injection molded “quick stop” cap is designated generally by the reference numeral 90 and comprises an end or facing element 92 and a perpendicularly extending tab element 94. Depressions 96 are formed in the rear surface 92′ of the end element 92 for reception of the ends of the male connectors 54 on a base element such as the element 50 of FIG. 1. An opening 98 can be formed through the tab element 94 for reception of a screw of the like (not shown) to attach the same to a supporting surface through the floor 52 of the base element 50.

The quick stop cap 90 may be used to cover the end or ends of a bumper assembly, particularly adjacent a flat surface such as an intersecting wall or a door frame (not shown). Following the attachment of a base element such as 50 to the supporting surface, a first quick stop cap such as 90 may be affixed at one end by drilling or otherwise attaching a screw (not shown) through the opening 98 and the floor 52 of the base element 50 to secure the stop cap 90 directly to the supporting surface. It is to be noted that the tab 94 is spaced slightly upwardly from the lower end 92″ of the end element 92 to permit the floor element 52 of the base element to underly the same, and the width of the tab element 94 is such as to fit between the stems 56 of the male connectors 54.

The other ends of the male connectors 54 of bumper can then be engaged in the depressions. 0.96 of a further quick stop cap and screwed through the tab element 94 to a supporting surface. A bumper element 70 can then be seated on the base element 50 by simple pressure on the arch 71 of the bumper element 70.

Alternatively, at the opposite end of a run, if necessary, the bumper element can be lifted slightly so that one of the other accessories to be discussed hereinbelow can be secured to the bumper assembly and the bumper element 70 pressed into position on the base element 50 adjacent thereto.

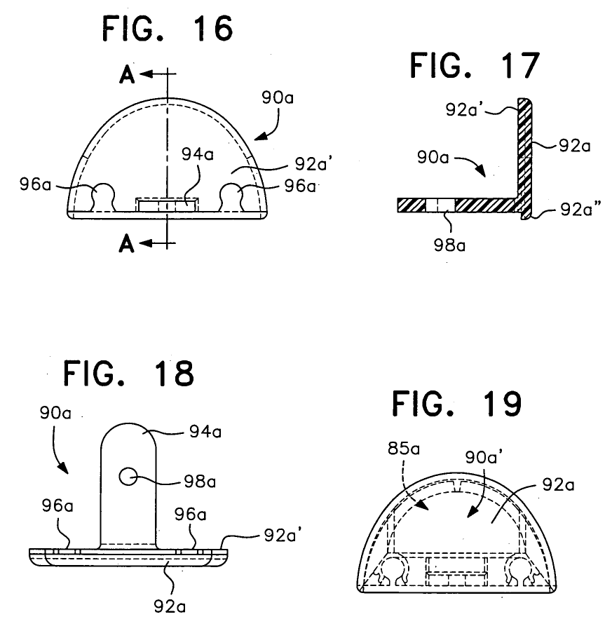

With reference now to FIGS. 16-19, the construction and assembly of a 2″ quick stop cap 92a are designated by the same reference characters as the 1″ quick stop cap of FIGS. 12-15, followed by the suffix “a”.

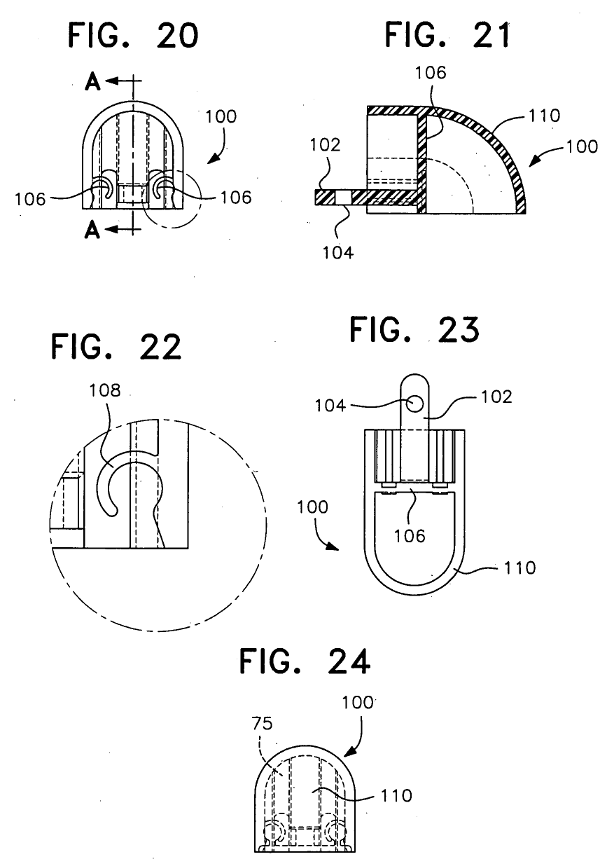

With reference now to FIGS. 20-24, an injection molded 1″, “snap-on” cap is identified by the reference numeral 100 which, in part, is similar to the stop cap 90, but includes an arcuate end portion for aesthetic purposes as illustrated at 100. The snap-on cap 100 is similar to the stop cap 90 in having a slightly raised tab element 102 with an opening 104 therethrough affixed to an element 106, but includes a pair of integrally molded arcuate female connectors 108 to snap over the male connectors 54 of a base element such as shown at 50 and an arcuate extension 110 to provide a more aesthetic appearance where a flat end cap is not necessary.

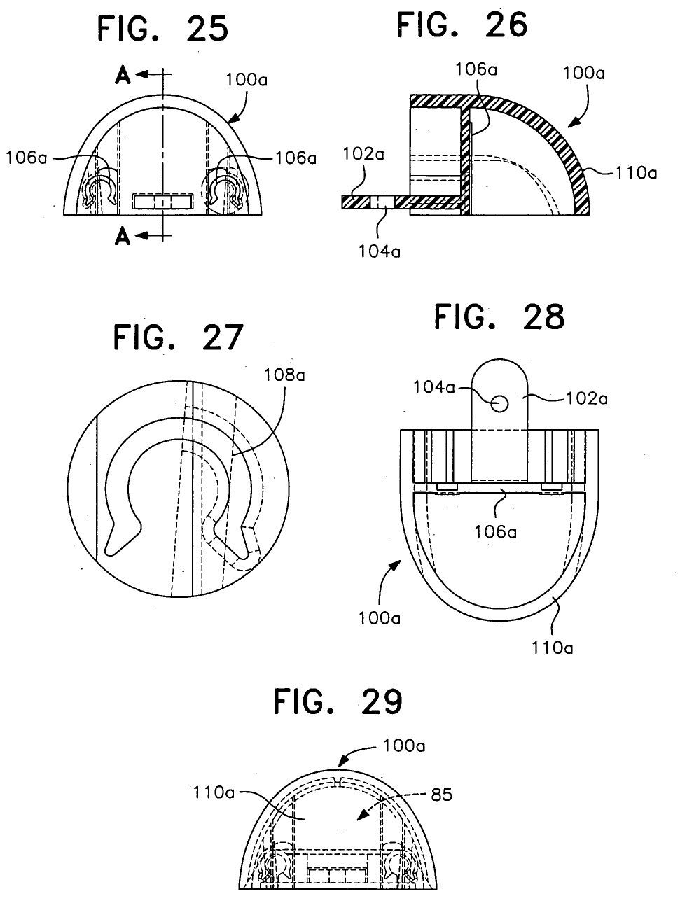

In FIGS. 25-29, a 2″ snap-on cap 100a is designated by the same reference characters as the 1″ snap-on cap 100 of FIGS. 20-24, followed by the suffix “a”.

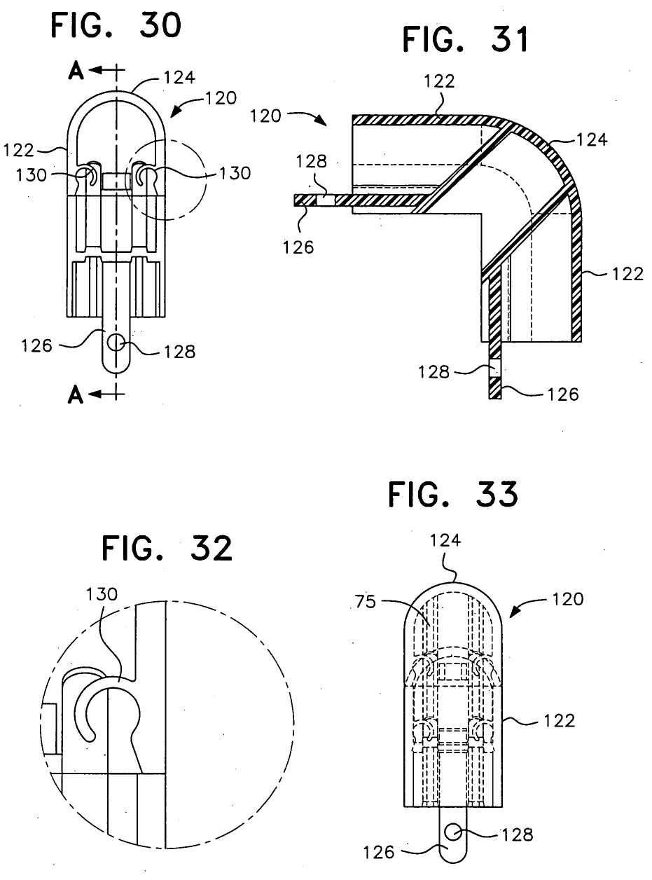

With reference to FIGS. 30-33, a 1″ injection molded “snap-on 90°” cap is seen at 120 and is adapted to interconnect a pair of bumper assemblies such as shown at 75 in FIG. 3 on perpendicular sides of a square or rectangular item to be protected from impact such as a grocery island, a freezer case or a merchandise display case (not shown). The 90° cap 120 is similar to the snap-on cap 100 of FIGS. 20-24, but includes a pair of snap-on sections 122, 122 perpendicularly connected by a 90° arcuate connecting section 124 to enable the same to pass around a corner. Each section 122 includes a tab element 125 with an aperture 128 and a pair of arcuate female connectors 130.

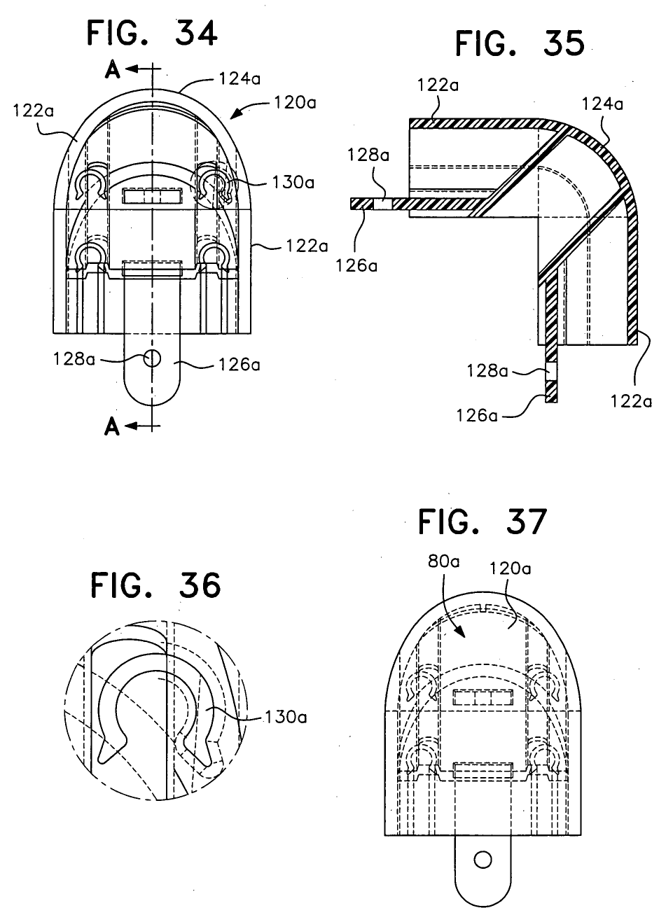

In FIGS. 34-37, a 2′ snap-on 90° cap 120a is designated by the same reference characters as the 1″ snap-on 90′ cap 100 followed by the suffix “a”.

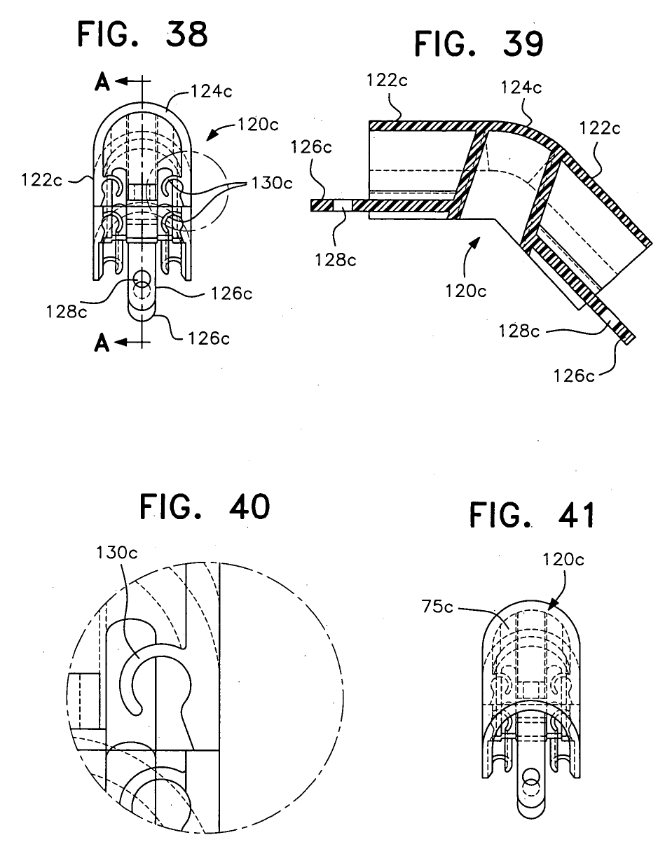

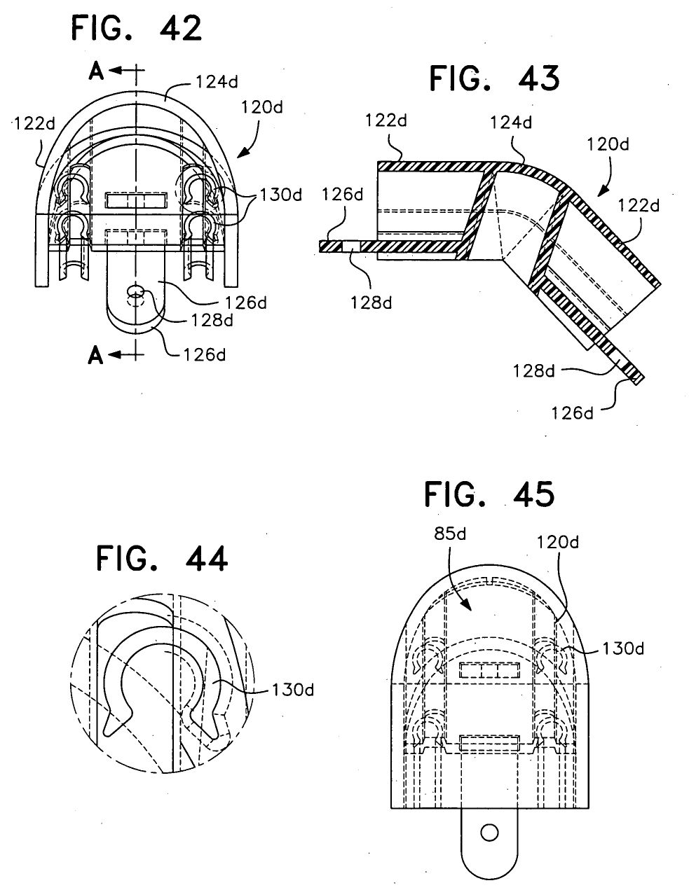

In FIGS. 38-41 and 42-45, illustrative injection molded 1″ and 2″ snap-on caps are designated by the same reference characters as the 1″ 90°, illustratively shown as 135°, snap-on cap 120 followed by the suffixes “c” and “d”, respectively, These caps are substantially identical to the 90° caps, except that the arcuate connecting sections have angles other than 90° to enable bumper assemblies to be interconnected around a hexagonal or other shaped unit to be protected, rather than a square or rectangular unit. Obviously, snap-on caps of various angular orientations can be provided for unique display cases or the like.

The use and operation, as well as the attendant advantages, of the bumper assemblies and the above-described accessories will be obvious to the skilled artisan. A base element and selected end cap or corner are first screwed or otherwise connected to the surface to be protected. One end of a bumper element is then engaged against the end cap or corner and pressed against the base element over its length. The opposite end of the bumper element may be lifted sufficiently to secure another end cap or corner and the assembly is then completed.

The foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

1. A protective bumper strip assembly for protecting supporting surfaces from impact comprising:
an elongated base member comprising a planar floor attachable to a supporting surface to be protected, said floor including an outer surface engageable with a supporting surface to be protected and an inner surface facing an elongated bumper attachable to said base member, and base member locking elements extending from said inner surface of said floor;
an elongated bumper attachable to said base member comprising an outer impact-receiving portion and including bumper locking elements for press-fit interengagement with said base member locking elements to releasably lock the bumper to the base member.

2. The bumper strip assembly of claim 1, wherein said interengagement between the bumper locking elements and base member locking elements is a ball and socket interengagement.

3. The bumper strip assembly of claim 1, wherein said base member locking elements comprise a pair of longitudinally extending, transversely spaced male connectors.

4. The bumper strip assembly of claim 3, wherein each said male connector comprises a stem portion extending from said inner surface of said floor and a bulbous head portion integral with said stem portion for receiving a bumper locking element.

5. The bumper strip assembly of claim 1, wherein at least one of said base member locking elements and bumper locking elements includes a means for increasing friction therebetween.

6. The bumper strip assembly of claim 5, wherein said means for increasing friction includes a coating.

7. The bumper strip assembly of claim 6, wherein said coating is a thermoplastic urethane.

8. The bumper strip assembly of claim 6, wherein said coating is coextruded with at least one of said base member locking elements and bumper locking elements.

9. The bumper strip assembly of claim 1, wherein said base member is extruded plastic.

10. The bumper strip assembly of claim 1, wherein said base member is metal.

11. The bumper strip assembly of claim 1, wherein said outer impact-receiving portion of said bumper is of a rigid plastic material.

12. The bumper strip assembly of claim 1, wherein said outer impact-receiving portion of said bumper is of a flexible plastic material.

13. The bumper strip assembly of claim 12, wherein said bumper locking elements are of a rigid plastic material.

14. The bumper strip assembly of claim 4, wherein said bumper locking elements include a pair of longitudinally extending, transversely spaced arcuate female connectors.

15. The bumper strip assembly of claim 14, wherein said arcuate female connectors are of complementary shape to said bulbous head portion and extend substantially around the bulbous head portion to provide a gripping contact on interior and exterior facing portions of said bulbous head portion.

16. The bumper strip assembly of claim 15, wherein said female connectors are connectable to each other by a bridge element.

17. The bumper strip assembly of claim 1, wherein said bumper is extruded PVC.

18. The bumper strip assembly of claim 1, wherein the base member locking elements and bumper locking elements are mechanically and frictionally interconnected to reduce relative movement therebetween when said bumper is impacted.

19. The bumper strip assembly of claim 1, wherein said outer impact-receiving portion of said bumper comprises an arcuate wall, and a pair of substantially parallel walls integral therewith.

20. The bumper strip assembly of claim 19, wherein said pair of substantially parallel walls extend away from the arcuate wall toward said base member and cover the floor of said base member.

21. The bumper strip assembly of claim 1, wherein each of said base member and said bumper have at least one free end, and wherein said assembly further comprises at least one end cap engageable with said free end of the base member and including an end cap surface covering said free end of said bumper.

22. The bumper strip assembly of claim 21, wherein said end cap surface is flat.

23. The bumper strip assembly of claim 21, wherein said end cap surface includes a substantially curved portion.

24. The bumper strip assembly of claim 21, wherein said end cap includes a mounting tab that extends from said end cap surface and overlies a portion of said inner surface of said floor of said base member.

25. The bumper strip assembly of claim 21, wherein said end cap surface engages a free end portion of said base member locking elements.

26. The bumper strip assembly of claim 24, wherein said end cap includes a second mounting tab for connection with an adjacent base member.

27. A protective bumper strip assembly arrangement comprising,
a first bumper strip assembly comprising a first elongated base member comprising a planar floor attachable to a supporting surface to be protected, said floor including an outer surface engageable with a supporting surface to be protected and an inner surface facing a first elongated bumper attachable to said first base member, and first base member locking elements extending from said inner surface of said floor; a first elongated bumper attachable to said first base member comprising an outer impact-receiving portion and including bumper locking elements for press-fit interengagement with said first base member locking elements to releasably lock the first bumper to the first base member;
a second bumper strip assembly comprising a second elongated base member comprising a planar floor attachable to a supporting surface to be protected, said floor including an outer surface engageable with a supporting surface to be protected and an inner surface facing a second first elongated bumper attachable to said base member, and base member locking elements extending from said inner surface of said floor; a second elongated bumper attachable to said second base member comprising an outer impact-receiving portion and including bumper locking elements for press-fit interengagement with said second base member locking elements to releasably lock the second bumper to the second base member; and
an end cap interengaging element for interconnecting the first and second strip assemblies.

28. The protective bumper strip assembly arrangement of claim 27, wherein each of said first and second bumper strip assemblies, including base members and bumpers thereof, have at least one free end surface, and wherein said end cap includes first and second mounting tabs that overlie a portion of said first and second floors, respectively, and includes a wall surface for enclosing the space between said first and second bumper strip assemblies.

29. A protective bumper strip assembly for protecting supporting surfaces from impact comprising:
an elongated base member comprising a planar floor attachable to a supporting surface to be protected, said floor including an outer surface engageable with a supporting surface to be protected and an inner surface facing an elongated bumper attachable to said base member, and base member locking elements extending from said inner surface of said floor comprising a pair of longitudinally extending, transversely spaced rails each including a stem portion extending from said inner surface of said floor and a bulbous head portion integral with said stem portion for receiving a bumper locking element;
an elongated bumper attachable to said base member comprising an outer impact-receiving portion and including bumper locking elements for press-fit interengagement with said base member locking elements to releasably lock the bumper to the base member;
wherein said bumper locking elements include a pair of longitudinally extending, transversely spaced arcuate female connectors of complementary shape to said bulbous head portion each of which extends substantially around the bulbous head portion to provide a gripping contact around said bulbous head portion; and
wherein at least one of said base member locking elements and bumper locking elements includes a means for increasing friction therebetween.

30. The bumper strip assembly of claim 29, wherein said means for increasing friction includes a coating.

31. The bumper strip assembly of claim 30, wherein said coating is a thermoplastic urethane.

32. The bumper strip assembly of claim 31, wherein said coating is coextruded with at least one of said base member locking elements and bumper locking elements.
